(19) United States
(12) Patent Application Publication
(10) Pub. No.: US 2006/0004751 A1
(43) Pub. Date: Jan. 5, 2006

(54) Changer-type information recording apparatus

(75) Inventors: Masanori Ujino, Osaka (JP); Akihiro Yuba, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO. LTD.

(21) Appl. No.: 11/135,412

(22) Filed: May 24, 2005

(30) Foreign Application Priority Data
Jun. 2, 2004 (JP) P2004-164031

(51) Int. Cl. G06F 17/30

(52) U.S. Cl. 707/6

(57) ABSTRACT

A changer-type information recording apparatus includes: a disc holding unit for putting plural discs on trays; a receiving unit for receiving a distributed signal including program data that includes a program title; a recording control unit for selecting one of the plural discs held on the trays of the holding unit and for recording the distributed signal received by the receiving unit; a keyword group management unit for managing keywords in keyword groups into which keywords are classified; and an input unit for a user to input one or more keywords. The recording control unit searches for the program data by using the input keyword among each of the keyword groups managed by the keyword group management unit, and records the distributed signal of the program, which includes the input keyword, on one of the discs, which corresponds to the keyword group including the input keyword.

### BACKGROUND OF THE INVENTION

1. Field of the Invention

The present invention relates to a changer-type information recording apparatus enabled to perform a keyword search using program data, which represents a program guide and is included in EPG data represented by a digital broadcasting signal, and to record the searched programs.

2. Description of the Related Art

Hitherto, there have been proposed various information recording apparatuses enabled to perform a keyword search using program data, which represents a program guide and is included in EPG data represented by a digital broadcasting signal, and to record the searched programs.

In a case where plural keywords of various categories are set in such an information recording apparatus, programs of multiple categories are randomly recorded on a single disc. Thus, such information recording apparatuses have encountered a problem that it takes time and labor to edit the recorded programs.

Meanwhile, as a means for solving such a problem, there has been proposed a recording control apparatus (see, for example, JP-A-2002-10208) that determines the category of a program according to program data transmitted by a digital TV broadcasting signal, and that selects a recording unit, the category assigned to which is matched with the category of the program to record, among recording units to which the categories of programs are respectively assigned, and that records the program on the selected recording unit.

### SUMMARY OF THE INVENTION

According to the aforementioned recording control apparatus, the program can be recorded on a recording unit, to which the category of this program is assigned, among recording units, to which the categories of programs are respectively assigned.

However, the conventional recording apparatus determines the category of the program according to the program data transmitted by the digital TV broadcasting signal. Thus, the conventional recording apparatus has encountered the following problem. For example, even in a case where a user wishes to record only programs of a specific kind of sport game, such as a baseball game or a soccer game, programs of all kinds of sport games included in a sport game category are recorded in a recording unit so that the recorded programs of various kinds of sport games coexist therein. Thus, for instance, in a case where the user wishes to record programs of soccer games, it is necessary that the user should once cancel a mode in which programs are recorded according to the categories thereof, and that the user newly sets a keyword “soccer”.

Further, in a case where a certain recording unit is set to record programs of a comedy category, all programs of a comedy are recorded therein. However, in a case where the user wishes to record only programs on which his/her favorite comedians, for example, “COMEDIAN 1” and “COMEDIAN 2” appear, among programs of the comedy category, similarly, it is necessary that he/she once cancels a mode of recording programs according to the category thereof, and that he newly sets plural keywords “COMEDIAN 1” and “COMEDIAN 2” on a case-by-case basis.

The invention is created to solve such problems. Accordingly, an object of the invention is to provide a changer-type information recording apparatus enabled to make discs, which respectively correspond to user-definable categories, by constructing the concept of each category, to which the conventional program data provides only a single meaning, in such a way as to permit a user to define each category in more detail.

To solve the problems, according to an aspect of the invention, there is provided a changer-type information recording apparatus, including: a disc holding unit for putting plural discs on trays, and for changeably holding the plural discs; a receiving unit for receiving a distributed signal including program data that includes a program title; a recording control unit for selecting one of the plural discs held on the trays of the holding unit and for recording the distributed signal received by the receiving unit; a keyword group management unit for managing keywords in keyword groups into which keywords are classified; and an input unit for a user to input one or more keywords to be managed in the keyword groups; wherein the changer-type information recording apparatus is enabled to perform a keyword search using the program data and to record a thus searched program; and the recording control unit searches for the program data by using the input keyword among each of the keyword groups managed by the keyword group management unit, and records the distributed signal of the program, which includes the input keyword, on one of the discs, which corresponds to the keyword group including the input keyword.

That is, according to the invention, keywords inputted by a user are managed in the unit of a keyword group into which the keywords are classified. When programs are recorded on an optional disc, the programs are recorded by managing the keywords in the unit of this keyword group. This enables the recording of programs of a user-defined group of keywords (that is, a keyword group) on each disc. For example, when the word “comedy” is set as the name of a keyword group and the expressions “COMEDIAN 1 (specific comedian's name)” and “COMEDIAN 2 (specific comedian' s name) “are set as keywords of this group, only programs, on which “COMEDIAN 1” or “COMEDIAN 2” appear, are recorded on a disc corresponding to this keyword group. Consequently, the invention can enable the manufacture of a disc, on which user favorite programs are recorded.

In this case, the apparatus may be configured so that the keyword group is set corresponding to each of the trays, and that the distributed signal of the program, which includes the keyword belonging to the keyword group, is recorded on the one of the discs mounted on the tray.

In a case where the keyword group is set corresponding to each of the trays, even when the one of the discs, which is mounted on the tray, is full, a program including the keyword of the same keyword group can continuously be recorded on another disc.

Further, the apparatus may be configured as follows. That is, the keyword group is recorded on an information region of each of the discs. When the one of the discs is loaded by being mounted on an optional one of the trays, the recording control means reads the keyword group from the information region from the one of the discs, which is loaded. The recording means records a broadcasting signal representing a program, which includes the keyword belonging to the read keyword group, on the one of the discs, which is on the optional one of the trays.

In a case where the keyword group is recorded in the information region of the disc, regardless of the tray on which the optical disc 1 is mounted, programs including the keywords belonging to the keyword group set in the disc can surely be recorded thereon. That is, the invention can surely prevent an occurrence of a trouble that an erroneous program is recorded on the disc.

Further, the apparatus may be configured so that the keyword group is set in such a way as to correspond to both an optional one of the trays and an optional disc mounted on the optional one of the trays, that when the keyword group set corresponding to the optional one of the trays is matched with the keyword group set in the optional disc, the recording control means records a broadcasting signal of a program, which includes the keyword belonging to the matched keyword group, on the optional one of the discs, and that when the keyword group set corresponding to the optional one of the trays differs from the keyword group set in the optional disc, the recording control means issues a warning to a user.

In a case where the keyword group is set in such a way as to correspond to both an optional one of the trays and an optional disc mounted on the optional one of the trays, the recording control means can issue a warning message, which indicates that the keyword group set corresponding to the optional one of the trays differs from the keyword group set in the optional disc, for example, when the disc, in which the keyword group “game” is set, is mounted on the tray corresponding to which the keyword group “comedy” is set.

Incidentally, according to the invention, the name of the keyword group is not limited to the categories of programs, for example, “comedy” and “sport game”. For instance, specific user names or “father”, “mother”, “sister” or “brother” may be used as the group name. A disc for each individual user can be manufactured by setting the specific user name as the group name.

The changer-type information recording apparatus according to the invention classified into keywords, which are inputted by a user, into keyword groups, and manages the keywords in the unit of a keyword group. When programs are recorded on an optional disc, the programs are recorded by managing the keywords in the unit of this keyword group. This enables the recording of programs of a user-defined group of keywords (that is, a keyword group) on each disc.

### BRIEF DESCRIPTION OF THE DRAWINGS

FIG. 1 is a block diagram illustrating the system configuration of a changer-type information recording/reproducing apparatus according to the invention;

FIGS. 2A and 2B are schematic plan diagrams each illustrating a changer portion of the changer-type information recording/reproducing apparatus according to the invention, which are taken from above;

FIG. 3 is an explanatory diagram illustrating a file structure of a management file for managing search keywords according to the names of groups into which search keywords are classified;

FIG. 4 is an explanatory diagram illustrating keywords, each of which is singly set for a corresponding one of trays, and the corresponding relation between a keyword group, which is set for each of the remaining trays, and each of keywords of the set keyword group; and

FIG. 5 is an explanatory diagram illustrating a file structure of a management file for managing search keywords according to the names of groups into which search keywords are classified.

### DETAILED DESCRIPTION OF THE PREFFERED EMBODIMENTS

Hereinafter, embodiments of the invention are described hereinbelow by referring to the accompanying drawings.

A changer-type information recording/reproducing apparatus according to this embodiment is enabled to accommodate and hold plural (for example, five) optical discs, and to select one of the optical discs and record data on the selected optical disc.

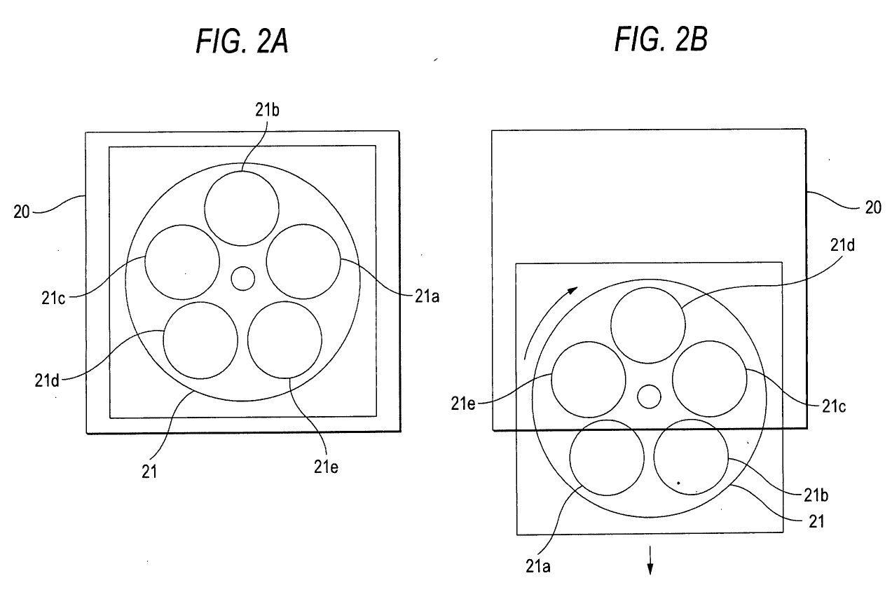

As shown in FIGS. 2A and 2B, the changer-type information recording/reproducing apparatus of this embodiment has a tray body 21 on which five optical discs can be mounted at the same time. When an optical disc is mounted thereon or replaced therefrom, an open/close button (not shown) provided on an apparatus body 20 is operated to thereby forwardly draw out a part of the tray body 21 from the apparatus body 20.

Further, when forwardly drawn out, two trays 21a and 21b of the tray body 21 are forwardly exposed. That is, two optical discs mounted on these two trays 21a and 21b can simultaneously be replaced.

Furthermore, in a case where a user wishes to replace optical discs mounted on the other trays 21c to 21e, he operates a disc change button (not shown) provided on the apparatus body 20 once. The tray body 21 then makes a (⅕)-turn clockwise, as viewed in the figure, in a state in which a part thereof is exposed, so that the next tray 21c is newly exposed. That is, the tray 21a goes into the apparatus body 20, so that the trays 21b and 21c are exposed. Similarly, when the disc change button is operated once more, the tray body 21 further makes a (⅕)-turn clockwise, so that the trays 21c and 21a are exposed.

Thus, optical discs can be mounted on all the trays 21a to 21e, and the optical disc already mounted thereon can be replaced with new one 1 by operating the disc change button in this way.

Furthermore, the tray body 21 is adapted to turn in the apparatus body 20. That is, when an optical disc, on which a program is recorded, or from which a program is reproduced, is selected (or a corresponding tray is selected (by using a remote controller (not shown)), the tray body 21 is turned so that the tray, on which this optical disc is mounted, is moved to a recording or reproducing position (for example, the position of a tray 21b, which is shown in FIG. 2A).

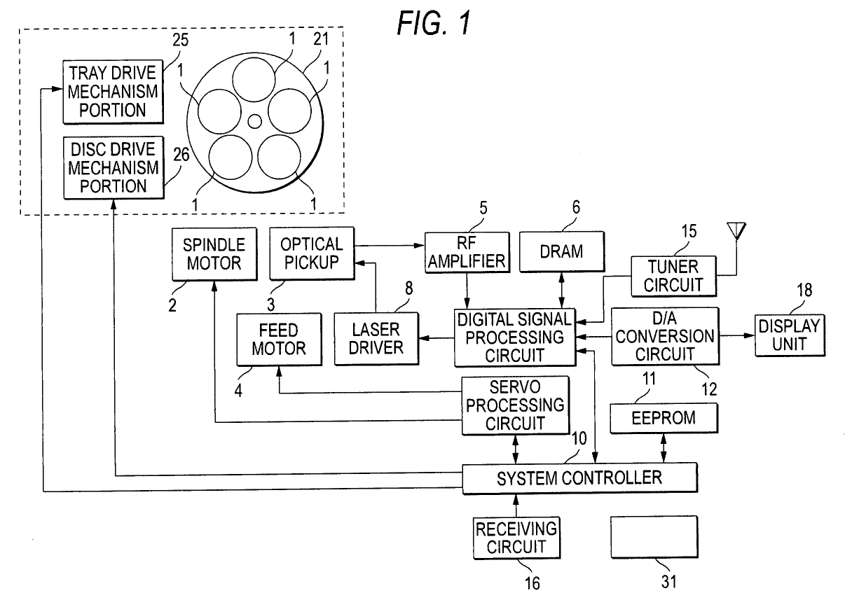

FIG. 1 shows the system configuration of the changer-type information recording/reproducing apparatus having the aforementioned constitution.

As described above, the changer-type information recording/reproducing apparatus of this embodiment has the tray body 21 on which five optical discs are mountable. This apparatus has a tray drive mechanism portion 25 for rotation-driving the tray body itself 21, and also has a disc drive mechanism portion 26 for chucking an optical disc 1 mounted on the tray (for instance, the tray 21b shown in FIG. 2A) placed at the recording position (or the reproducing position) during a recording operation (or a reproducing operation) and for rotation-driving this optical disc 1.

An output of an optical pickup 3 for writing data to the loaded optical disc 1 and for reading data therefrom is connected to a digital signal processing circuit 7 through an RF amplifier 5, whose output is connected to a laser driver 8 for controlling a laser output when data is written to or read from the optical disc by the optical pickup 3. Further, an output of the servo processing circuit 9 is connected to a feed motor 4, which is used for moving the optical pickup 3 in a radial direction of the optical disc 1, and to spindle motor 2 for rotation-driving the optical disc 1. The digital signal processing circuit 7 and a servo processing circuit 9 are bidirectionally connected to a system controller 10 for controlling an operation of the entire apparatus.

A DRAM 6 serving a buffer for temporarily storing data in a recording operation and a reproducing operation is bidirectionally connected to the digital signal processing circuit 7. Also, a D/A conversion circuit 12 for converting digital data to analog data and for outputting the analog data to a display unit 18, such as a CRT, is connected to the digital signal processing circuit 7. Moreover, a tuner circuit (for instance, a BS tuner, or a CS tuner) 15 is connected to the digital signal processing circuit 7.

An EEPROM 11 for storing inherent data, such as parameters of the optical disc 1 and those of a laser power, is bidirectionally connected to the system controller 10. Also, a receiving portion 14 for receiving an infrared signal from the remote controller 31 is connected to the system controller 10.

The digital signal processing circuit 7 performs a process of separating data, which is represented by a 16-bit signal, into 8-bit data and of converting the 8-bit data into 14-bit data according to an error correction system based on an EFM demodulation and ACIRC (Advanced Cross Interleaved Reed-Solomon Code). Further, the digital signal processing circuit 7 performs audio extension of demodulated audio data and outputs resultant data to the D/A conversion circuit 12. Then, the D/A conversion circuit 12 converts the extended audio data into an analog signal and outputs the analog signal. Furthermore, the digital signal processing circuit 7 performs data compression on a digital television broadcasting signal received by the tuner circuit so as to write the signal to the optical disc 1.

The system controller 10 controls an operation of the entire apparatus. When an optical disc 1 is mounted on the tray body 21, or when the optical disc 1 mounted thereon is replaced, the system controller controls the tray drive mechanism portion 25. When data is recorded on an optical disc 1 placed at the recording position, the system controller 10 controls the disc drive mechanism portion 26.

With the aforementioned configuration, this embodiment is enabled to perform a keyword search using EPG data (or program data) representing an electronic program guide included in a digital signal broadcasting signal. The keyword search using EPG data is a known technique. Thus, the description of the keyword search using EPG data is omitted herein.

In this embodiment, the search keywords are managed in the unit of a group set by the user using, for example, the remote controller 31. Data representing the keywords is stored in a management space, for example, the EEPROM 11 in the form of a file. Hereinafter, practical embodiments of a feature of the invention for managing the search keywords are described in detail.

### First Embodiment

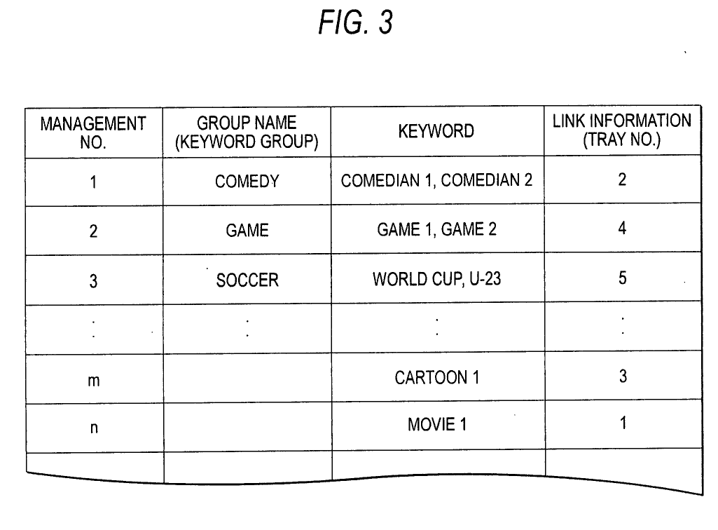

FIG. 3 shows an example of the structure of a management file for managing the search keywords in the unit of a group into which the keywords are classified. This management file has a management number item, a group name item, a keyword item, and a link information item. A group name set by the user is written to the column of the group name item. Incidentally, the group name may be set so that the user can easily understand the attributes of a group by the group name thereof. The group names do not necessarily correspond to keywords represented by the EPG data. In this example, the words “comedy”, “game”, and “soccer” are set in the columns of the group name corresponding to the management numbers “1”, “2”, and “3”, respectively.

Further, in a cell of the column of the keyword corresponding to the management number “1”, two keywords “COMEDIAN 1 (specific comedian's name)” and “COMEDIAN 2 (specific comedian's name)” are set by the user as the detail data included in the keyword group “comedy”. In a cell of the column of the keyword corresponding to the management number “2”, two keywords “GAME 1 (specific game's name)” and “GAME 2 (specific game's name)” are set by the user as the detail data included in the keyword group “game”. In a cell of the column of the keyword corresponding to the management number “3”, two keywords “WORLD CUP” and “U-23” are set by the user as the detail data included in the keyword group “soccer”.

Thus, one or more user-specified keywords are managed in the unit of a keyword group, that is, managed by the group name. Therefore, in a case where plural keywords are set in one optical disc, all the keywords included in the keyword group having the group name can be set therein by setting only the group name instead of inputting and setting all the plural keywords therein.

That is, when the user inputs and sets an arbitrary group name, the system controller 10 searches the EPG data for programs, which include the keywords of the keyword group having the group name, and extracts the searched programs from the EPG data. Then, the extracted programs are sequentially recorded on the optical disc 1.

Herein, in a cell of the column of link information, information for designating what tray, on which an optical disc is to be mounted, is used for writing the program, which includes the set keyword, on this optical disc, or what optical disc is used as a disc to which such a program is written. In this example, the tray number “2” is written in a cell of the column of link information corresponding to the management number “1”. The tray number “4” is written in a cell of the column of link information corresponding to the management number “2”. The tray number “5” is written in a cell of the column of link information corresponding to the management number “3”. The user can freely determine the corresponding relation between the keyword groups and the trays, to which the keyword groups to set are respectively allocated. It is now assumed that the tray number “1” corresponds to the tray 21a shown in FIGS. 2A and 2B, that the tray number “2” corresponds to the tray 21b, that the tray number “3” corresponds to the tray 21c, that the tray number “4” corresponds to the tray 21d, and that the tray number “5” corresponds to the tray 21d.

That is, the first embodiment is adapted so that the keyword groups are set respectively corresponding to the trays. Concretely, for example, the keyword group “comedy” is set corresponding to the optical disc 1 mounted on the tray 21b corresponding to the tray number “2”. Thus, the system controller 10 extracts the search keywords “COMEDIAN 1” and “COMEDIAN 2” included in this keyword group from the management file, and sequentially records only programs, which include these keywords, on the optical disc 1 mounted on the tray 21b corresponding to the tray number “2”.

Further, the expression “CARTOON 1 (specific cartoon's name)” is set as the keyword only in a cell of the column of the keyword corresponding to the management number “m” in the management file shown in FIG. 3. The tray number “3” is written in a cell of the column of the corresponding link information. Furthermore, the expression “MOVIE 1 (specific movie's nam)” is set as the keyword only in a cell of the column of the keyword corresponding to the management number “n”. The tray number “3” is written in a cell of the column of the corresponding link information. Thus, in the case where a keyword is set only in a cell of the column of the keyword, a conventional keyword search is performed. Programs associated with the keyword are recorded on the optical disc mounted on the tray having the tray number written to the cell of the column of the link information.

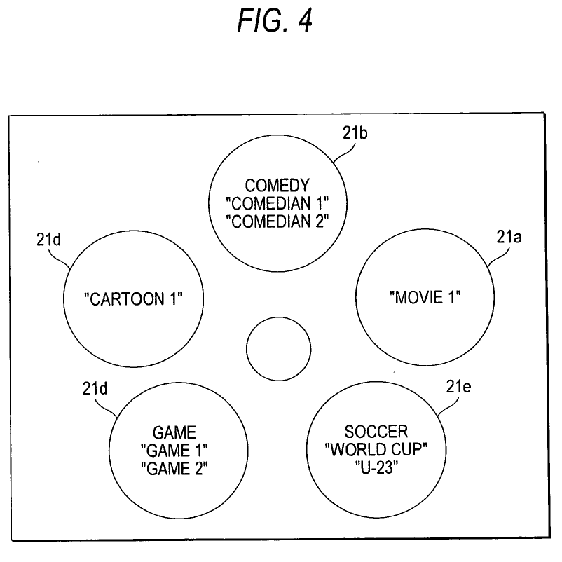

Incidentally, FIG. 4 is an explanatory diagram illustrating keywords, each of which is singly set for a corresponding one of trays according to the data stored in the management file shown in FIG. 3, and the corresponding relation between a keyword group, which is set for each of the remaining trays according to the data stored in the management file shown in FIG. 3, and each of keywords of the set keyword group.

Additionally, in the first embodiment, the management of the keyword groups and the keywords is unified by using the management file in the apparatus body. Thus, for example, even when a keyword is added to those corresponding to an optional tray, the new keyword is added to those corresponding to the tray having the tray number written in the cell of the column of the link information only by adding a desired keyword to a cell of the column of the key word of the corresponding keyword group in this management file. For instance, a new keyword “COMEDIAN 3 (specific comedian's name)” is added to those corresponding to the tray 21b, that is, the tray number “2” only by adding the keyword “COMEDIAN 3” to the cell of the column of the keyword corresponding to the keyword group “comedy”. That is, the first embodiment has advantages in that the addition, the deletion, and the change of a new keyword can be performed in an integrated manner instead of being performed on each of the trays.

### Second Embodiment

Although the keyword group is set corresponding to each of the trays in the first embodiment, the keyword group is set corresponding to each of the optical discs in the second embodiment. Thus, according to the second embodiment, an ID code unique to the optical disc 1 is written to a cell of the column of the link information of the management file shown in FIG. 3, instead of the tray number. That is, the second embodiment utilizes the management file shown in FIG. 3. Thus, it is assumed that the keyword groups and the keywords belonging to the keyword groups are preliminarily set in the management file, as shown in FIG. 3.

Further, the keyword group managed by using the management file is written to an information region of a lead-in area of the optical disc 1. Then, when this optical disc 1 is loaded into the apparatus body by being mounted on an optional tray, the system controller 10 reads data representing the keyword group from the information region of the loaded optical disc 1. Then, broadcasting signals representing programs, which include the keyword belonging to the keyword group represented by the read data, are recorded on the optical disc 1 mounted on this tray.

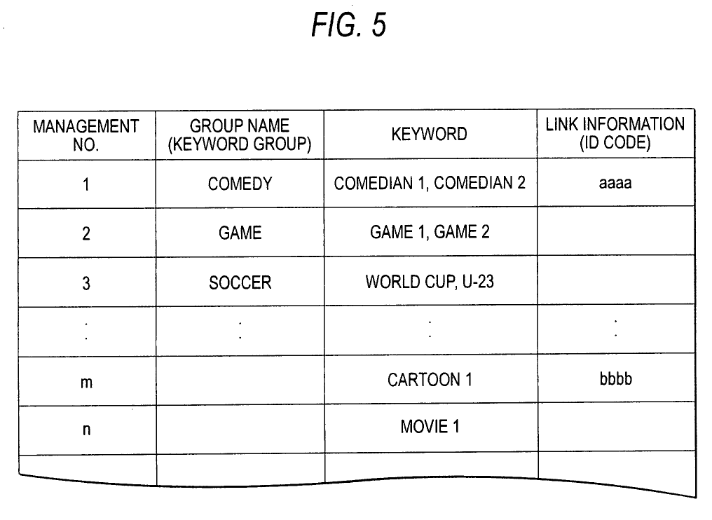

Concretely, for example, it is assumed that the “comedy” is recorded in the information region of the optical disc 1a as the name of the keyword group. When this optical disc 1a is mounted on an optional tray and is loaded into the apparatus body, the system controller 10 reads data representing the “comedy” as the name of the keyword group from the information region of the loaded optical disc 1a. Then, the system controller 10 searches the management file by using the “comedy” as a key. Subsequently, an ID code (for instance, “aaaa”) unique to this optical disc 1a is written to a cell of the column of the link information, which corresponds to the associated keyword group. FIG. 5 snows the management file that is in this state. Further, it is assumed that the expression “CARTOON 1” is written to the information region of the optical disc 1b as a keyword. When this optical disc 1b is mounted on an optional tray and is loaded into the apparatus body, the system controller 10 reads data representing the expression” CARTOON 1” as the keyword from the information region of the loaded optical disc 1b. Then, the system controller 10 searches the management file by using the keyword “CARTOON 1” as a key. In this case, there is no matched keyword in the column of the keyword group in the management file. Thus, the system controller 10 subsequently searches the column of the keyword. Then, as shown in FIG. 5, an ID code (for instance, “bbbb”) unique to this optical disc 1b is written to a cell of the column of the link information, which corresponds to the management number “m” associated with the cell of the column of the keyword, in which the matched keyword is present. Incidentally, in a case where, although the system controller 10 searches the keyword, no matched keyword is present, the keyword “CARTOON 1” is set in an empty cell of the column of the keyword, which corresponds to an optional management number. The ID code “bbbb” unique to the optical disc 1b is written to an associated cell of the column of the link information.

Consequently, the name “comedy” is set in, for example, the optical disc 1a, which is mounted on an optional tray, as the name of the keyword group. Thus, the system controller 10 extracts the search keywords “COMEDIAN 1” and “COMEDIAN 2” included in the keyword group “comedy” from the management file shown in FIG. 5. Only programs including these keywords are sequentially recorded on the optical disc 1a mounted on an optional tray. Further, no keyword group is set in, for example, the optical disc 1b mounted on an optional tray. However, the keyword “CARTOON 1” is set therein. Thus, the system controller 10 sequentially records only programs, which include the keyword “CARTOON 1”, on the optical disc 1b mounted on the optional tray.

Thus, according to the second embodiment, data representing the keyword group or the keyword is recorded on the information region of the optical disc 1. Regardless of the tray on which the optical disc 1 is mounted, programs including the keywords belonging to the keyword group set in the optical disc 1 or including the keyword singly set therein can surely be recorded thereon.

Incidentally, the second embodiment is constituted so that when the keyword group is set in the optical disc, only the keyword group is recorded on the optical disc, and that one or more keywords belonging to the keyword group are obtained by utilizing the management file shown in FIG. 5. However, the apparatus may be constituted so that not only data representing the keyword group nor data representing keywords, which belong to this keyword group, are recorded on the information region of the optical disc without using the management file shown in FIG. 5. In this case, the data representing the keyword group and the keywords read from the optical disc 1 are stored in, the DRAM 6, together with the ID code unique to the optical disc 1 and with the tray number of the tray, on which this optical disc 1 is mounted. Then, when a keyword search and the recording of programs are performed, according to the keywords stored in this DRAM 6, the system controller 10 sequentially records only programs, which include such keywords, on the associated optical disc 1 that is mounted on an optional tray.

### Third Embodiment

A third embodiment sets a keyword group in such a way as to be associated with both of an optional tray and an optional optical disc.

That is, the third embodiment is the same as the first embodiment in that the keyword groups are set respectively corresponding to trays. The keyword group is set by using the management file shown in FIG. 3. Also, the third embodiment is the same as the second embodiment in that the keyword group is set in each of the optical discs.

When the keyword group set corresponding to the tray is matched with that set in the optical disc, the system controller 10 records broadcasting signals representing programs, which include the keywords belonging to this keyword group, on this optical disc mounted on this tray. Concretely, for example, it is assumed that the name “comedy” is recorded as the name of the keyword group in the information region of the optical disc 1a, and that this optical disc 1a is mounted on the tray 21b corresponding to the tray number “2”. The keyword group “comedy” set corresponding to the tray 21b associated with the tray number “2” is matched with the keyword group “comedy” recorded in the optical disc 1a. Thus, the system controller 10 records only programs, which include the keywords “COMEDIAN 1” and “COMEDIAN 2” belonging to the keyword group “comedy”, on the optical disc 1a mounted on the tray 21b.

Conversely, in a case where the keyword group set corresponding to the tray differs from the keyword group set in the optical disc, the system controller 10 issues a warning to a user. Concretely, in a case where the optical disc 1a is mounted on the tray 21e corresponding to the tray number “5”, the keyword group “soccer” set corresponding to the tray 21e associated with the tray number “5” differs from the keyword group “comedy” set in the optical disc 1a. Thus, the system controller 10 displays a warning message, which indicates that the keyword groups are not matched, in the display unit 18 to a user. Consequently, the user knows that the optical disc 1a is mounted on an erroneous tray. At that time, the user can remount the optical disc 1a on a correct tray.

Meanwhile, in a case where a user wishes to additionally record programs, which correspond to the keyword group “soccer”, on the optical disc on which programs corresponding to the keyword group “comedy”, the user pushes a “decision” button (not shown) of the remote controller 31 in response to this warning message. Consequently, the system controller 10 nullifies the keywords recorded on the optical disc 1a according to the operation of pushing the “decision” button, and treats the keywords, which are set corresponding to the tray 21e, as valid keywords. Then, the system controller 10 additionally records only programs, which include the keywords “World Cup” and “U-23”, on the optical disc 1a. Incidentally, the system controller 10 may nullify the keywords set corresponding to the tray 21e and treat the keywords, which are recorded in the optical disc 1a, as valid keywords. Alternatively, a “selection” button, which is used for selecting which of the keywords is treated as valid keywords, may be provided on the remote controller 31, so that a user can freely select the keyword.

Incidentally, although the categories of programs, such as the “comedy” and the “sport game”, are employed as the group name of the keyword group, for instance, specific user names or “father”, “mother”, “sister” or “brother” may be used as the group name. Consequently, a disc for each individual user can be manufactured by setting the specific user name as the group name.

Moreover, this invention can be applied not only to a tray-type apparatus but also to a magazine-type apparatus.

What is claimed is:

1. A changer-type information recording apparatus comprising:
disc holding means for putting plural discs on trays, and for changeably holding the plural discs;
receiving means for receiving a broadcasting signal including program data that includes a title of a program;
recording control means for selecting one of the plural discs held on the trays of the holding means and for recording the broadcasting signal received by the receiving means;
keyword group management means for managing keywords in keyword groups into which keywords are classified; and
input means for a user to input one or more keywords to be managed in the keyword groups;
wherein the changer-type information recording apparatus is enabled to perform a keyword search using the program data and to record a thus searched program;
the keyword group is set in such a way as to be associated with both one of the trays and one disc mounted on the one of the trays;
when the keyword group set corresponding to the one of the trays is matched with the keyword group set in the one disc, the recording control means records the broadcasting signal of the program, which includes the keyword belonging to the matched keyword group, on the one disc; and
when the keyword group set corresponding to the one of the trays differs from the keyword group set in the one disc, the recording control means issues a warning to the user.

2. A changer-type information recording apparatus comprising:
a disc holding unit for putting plural discs on trays, and for changeably holding the plural discs;
a receiving unit for receiving a distributed signal including program data that includes a program title;
a recording control unit for selecting one of the plural discs held on the trays of the holding unit and for recording the distributed signal received by the receiving unit;
a keyword group management unit for managing keywords in keyword groups into which keywords are classified; and
an input unit for a user to input one or more keywords to be managed in the keyword groups;
wherein the changer-type information recording apparatus is enabled to perform a keyword search using the program data and to record a thus searched program; and
the recording control unit searches for the program data by using the input keyword among each of the keyword groups managed by the keyword group management unit, and records the distributed signal of the program, which includes the input keyword, on one of the discs, which corresponds to the keyword group including the input keyword.

3. The changer-type information recording apparatus according to claim 2, wherein the keyword group is set corresponding to each of the trays; and
the distributed signal of the program, which includes the keyword belonging to the keyword group, is recorded on the one of the discs mounted on the tray.

4. The changer-type information recording apparatus according to claim 2, wherein the keyword group is recorded on an information region of each of the discs;
when the one of the discs is loaded by being mounted on one of the trays, the recording control unit reads the keyword group from the information region from the one of the discs, which is loaded; and
the recording unit records the distributed signal of the program, which includes the keyword belonging to the read keyword group, on the one of the discs, which is on the one of the trays.

5. The changer-type information recording apparatus according to claims 2, wherein a group name of the keyword group is a specific user name.
